(19) United States
(12) Patent Application Publication
(10) Pub. No.: US 2017/0185981 A1
(43) Pub. Date: Jun. 29, 2017

(54) Methods for Online Media Collaboration and Licensing

(71) Applicant: Parker M.D. Emmerson, Chapel Hill, NC (US)

(72) Inventor: Parker M.D. Emmerson, Chapel Hill, NC (US)

(21) Appl. No.: 15/456,640

(22) Filed: Mar. 13, 2017

Related U.S. Application Data
(63) Continuation-in-part of application No. 14/611,471, filed on Feb. 2, 2015.
Application No. 14/611,471 is a continuation-in-part of application No. 13/916,494, filed on Jun. 12, 2013, now Pat. No. 8,962,964.
Application No. 13/916,494 is a continuation-in-part of application No. 12/494,945, filed on Jun. 30, 2009, now Pat. No. 8,487,173.
(60) Provisional application No. 61/133,481, filed on Jun. 30, 2008.

(51) Int. Cl. G06Q 20/12; H04L 29/06

(52) U.S. Cl. CPC G06Q 20/1235; H04L 63/062; G06Q 2220/18

(57) ABSTRACT

Systems and methods for granting media licensing are disclosed. A multiplicity of cryptocurrency nodes in a distributed cryptocurrency network are tailored for media licensing. The multiplicity of cryptocurrency nodes comprises at least one media licensing node and at least one media licensee node. The at least one media licensee node makes payment for a piece of media to a media licensing node owning the piece of media through the distributed cryptocurrency network. The distributed cryptocurrency network generates a license authorization key to the piece of media. The at least one media licensee node receives data for the piece of media data and the license authorization key after making the payment. The license authorization key converts the data for the piece of media to a piece of consumable media at the at least one media licensee node.

### CROSS-REFERENCE TO RELATED APPLICATIONS

This application relates to and claims priority from the following U.S. Applications. This application is a continuation-in-part of U.S. application Ser. No. 14/611,471 filed Feb. 2, 2015, which is a continuation-in-part of U.S. application Ser. No. 13/916,494 filed Jun. 12, 2013, now U.S. Pat. No. 8,962,964, which is a continuation-in-part of U.S. application Ser. No. 12/494,945 filed Jun. 30, 2009, now U.S. Pat. No. 8,487,173, which claims the benefit of U.S. Application No. 61/133,481 filed Jun. 30, 2008, each of which is incorporated by reference herein in its entirety.

### BACKGROUND OF THE INVENTION

Field of the Invention

The present invention relates generally to online music collaboration. Further, the present invention relates to methods for providing collaborative music compositions via a computer network.

Description of the Prior Art

It is known in the relevant art to provide for online music uploading and downloading. However, typically this is done for completed musical compositions. Some web-based options provide for musicians to collaborate on projects, but do not provide for collaborative groups or virtual bands. These sites provide for only one single track to be uploaded, not multiple tracks at the same or similar time from the same collaborative group. By way of example, there might be a guest member performing with an existing band on one track. Thus, there remains a need for online, collaborative group music compositions for multiple tracks. Also, there remains a need for selective grouping and multiple group collaborations on an ongoing basis with these methods.

### SUMMARY OF THE INVENTION

A first aspect of the present invention is to provide methods for creating and editing collaborative music compositions via a computer network, including remote uploading tracks by musicians. Another aspect of the present invention provides methods for creating and joining a band, at least one musician to join a virtual group of at least one other musician for the purpose of virtual collaborative creating, and/or editing music tracks remotely, via an online network and interactive website therefor. Alternatively, the present invention may provide methods for coders or software programmers to virtually collaborate on software, either as a team or individually.

The present invention also provides systems and methods for granting media licensing. A multiplicity of cryptocurrency nodes in a distributed cryptocurrency network are tailored for media licensing. The multiplicity of cryptocurrency nodes comprises at least one media licensing node and at least one media licensee node. The at least one media licensee node makes payment for a piece of media to a media licensing node owning the piece of media through the distributed cryptocurrency network. The distributed cryptocurrency network generates a license authorization key to the piece of media. The at least one media licensee node receives data for the piece of media data and the license authorization key after making the payment. The license authorization key converts the data for the piece of media to a piece of consumable media at the at least one media licensee node.

These and other aspects of the present invention will become apparent to those skilled in the art after reading the following description of the preferred embodiment when considered with the drawings, as they support the claimed invention.

### BRIEF DESCRIPTION OF THE DRAWINGS

FIG. 1 provides a home page GUI for a website operating according to one embodiment of the present invention.

FIG. 2 provides a band profile GUI for a website according to the present invention.

FIG. 3 provides a musician profile GUI for a website according to the present invention.

FIG. 4 provides a band search GUI for a website according to the present invention.

FIG. 5 provides a musician search GUI for a website according to the present invention.

FIG. 6 provides a musician's music GUI for a website according to the present invention.

FIG. 7 provides another band profile GUI for a website according to the present invention.

FIG. 8 provides a band music management GUI for a website according to the present invention.

FIG. 9 provides a band profile creation GUI for a website according to the present invention.

FIG. 10 provides a GUI for managing a song and the associated tracks according to the present invention.

FIG. 11 provides a data table architecture of a website according to the present invention.

FIG. 12 provides steps of uploading contents to the Myblogband network via an application.

FIG. 13 is a user interface of an application program for a media licensing platform on a hand-held device according to one embodiment of the present invention.

FIG. 14 displays different catelgories of music on the licensing platform according to one embodiment of the present invention.

FIG. 15 displays music by song on the licensing platform in an application program in one embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a method for creating and editing collaborative music compositions via a computer network, including remote uploading tracks by musicians. Additionally, the present invention provides methods for creating and joining a band, allowing at least one musician to join a virtual group of at least one other musician for the purpose of virtual collaborative creating and/or editing music tracks remotely, via an online network and interactive website therefor. Another embodiment of the present invention provides a method for creating and editing collaborative software programs via a computer network, including remote uploading of code by software programmers. The present invention provides for automated systems for providing online music composition including: an interactive website accessible from a remote computer device via a network, the website being operable for receiving a first track uploaded through the network from a first remote source, the first track created by at least one musician entity; the website further operable for automatically saving and categorizing the at least one track according to the musician entity and a music genre; the website further operable for receiving a second track from a second remote source, the second track created by a second musician entity, selectively combining the first track and the second track, and saving the combined tracks for creating a collaborative music composition. Preferably, the system is accessible remotely via a multiplicity of musician entities for uploading, editing, and creating collaborative music compositions selectively with other musician entities; remote access is based upon user accounts for the musician entities and their corresponding virtual bands, when they exist. The website is operable to provide for any of the musician entities to access and edit the collaborative music composition via network connection to the interactive website. Another embodiment of the website could provide for any coder or software programmer to access and edit the collaborative software composition via network connection to the interactive website.

Furthermore, the present invention provides for methods for providing online music composition including the steps of: providing an interactive website accessible with a remote computer via a network, wherein the website is operable for receiving a first track from a first remote source, the first track being created by at least one musician entity, saving and categorizing the at least one track according to musician and genre, receiving a second track from a second remote source, the second track created by a second musician entity, selectively combining the first track and the second track, and saving the combined tracks for creating a collaborative music composition.

Also the present invention provides for methods for online music collaboration including the steps of: providing an interactive website accessible with at least one remote computer device via a network, wherein the website is operable for receiving a first track from a first remote source, the first track being created by at least one musician entity, saving and categorizing the at least one track according to musician and genre, receiving a second track from a second remote source, the second track created by a second musician entity, selectively combining the first track and the second track, and saving the combined tracks for creating a collaborative music composition; and wherein the musician entities are self-selectively combinable to form at least one virtual band for online music creation, editing, and social network-based distribution through the interactive website.

Incorporation of attributes of contemporary social networks are further included in the present invention, including but not limited to: “friends,” “fans,” blogs, photos, videos, “like to share,” and update/RSS feeds. Additionally, the present invention may be embedded as an app into social network sites. Automatic scripting (syncing of a social network with the invention) may link the two accounts (*e.g., allow access to the invention through Facebook, Google or Twitter, or vice versa), such as through the use of an internet OpenID.

The methods further include the steps of editing the combined tracks, and the interactive website is operable for receiving a multiplicity of tracks from more than one remote musician entity. Advantageously, the interactive website systems and methods of the present invention are operable for automatically categorizing the virtual bands based upon a track categorization of composite tracks and/or based upon a musician categorization of any or all of the at least one musician entities that contribute at least one track to the composite track.

Definitions and defined terms, applicable to methods or systems of the inventions described herein, include but are not limited to the following:

The term “visitor” means any person who views the website.

The term “user” means any person, collection of persons, or entity who successfully registers with the website, or any band, virtual band or other collection of users.

The term “track” means any music track, whether created by one or more musicians, whether created online or offline, whether comprised of new music, combinations of previous tracks, edits of previous tracks or combinations of new music with previously-made tracks.

The term “song” means any collection of one or more tracks, the collection being represented by one track, designated as the song-track, which by default is set to play on the player, download, or be added to a playlist when a song is selected. In one embodiment of the invention, a user may add a song to a playlist without leaving the page where the user accesses the song. In another embodiment of the invention, a song is the equivalent of a folder housing one or more track files created by member(s) and/or guest member(s) of a virtual band, said folder having one track designated as the song-track.

The term “listener” means any user who is not a musician, band or virtual band.

The term “musician” means any user who uploads a unique track, creates a musician profile page, or is the member or guest member of a band.

The term “band” means any group of one or more musicians self-identified as a collective of musicians.

The term “virtual band” means any group of one or more musicians self-selectively combinable to collaborate musically to create at least one song.

The term “band member” means any musician who is the member of a band or virtual band.

The term “producer” is any user who posts a track, song, or playlist for download on the user's profile page.

The term “contributor” is any user who creates any item on the website, wherein the term item includes tracks, songs, or playlists. A contributor may be the musician(s) that create a song or track, or the producer of a playlist, or the musician(s) who created song(s) or track(s) included in a playlist.

The term “lyricist” is any musician who composes the words or lyrics for a track or song.

The terms “public accessibility” and “public availability” refer to any item on the website being so designated to be made available to any user or visitor so that they may download an item, play an item, add an item to a playlist, or a combination thereof

The terms “private accessibility” and “private availability” refer to any item on the website being so designated to be made available only to a select group of users having the right to download an item, play an item, add an item to a playlist, or a combination thereof

The terms “paid accessibility” and “paid availability” refer to any item on the website being so designated to be made available to a user in exchange for a fee being paid by the user, thereby granting the user the right to download an item, play an item, add an item to a playlist, or a combination thereof

Referring now to the drawings in general, the illustrations are for the purpose of describing a preferred embodiment of the invention and are not intended to limit the invention thereto.

Typically, according to the present invention, music tracks are composed, produced, and uploaded by at least one musician, often a single musician, to the site via an interactive website accessible through a GUI viewable on a display. The display is constructed and configured for interactive user inputs and audiovisual outputs through a computer device, such as a computer having access to the website via a network, such as the Internet. In one embodiment, the user accesses the website via a browser running on a computer device. Furthermore, as the description below primarily refers to a website, any of the below functions and descriptions are disclosed as further being applied to any application, software, or software-as-a-service that can be accessed through a device having a display.

Regarding methods for the present invention, a web-based graphic user interface (GUI) is provided with interactive functionality so that a user can enter personalized information, customize the content displayable on the user's profile page, and provide for messaging and commenting services. Upon registering with the website, either through the GUI or another method, a user's login for the website may be comprised of a user identification or email address and a password, which is used to uniquely identify the user's profile and/or account. Each user is either a musician or a listener having a unique and customizable profile or is a collection of at least one user having a unique profile. Collections of users may include, but are not limited to, a band, virtual band, or group, whose profile may be customized by an admin designated to represent the user collection or may be customized by all users or a subset of users belonging to the collection.

Once registered, a user may post comments to a profile page and message other users. Additionally, the user may personalize their own profile page by providing and editing, amongst other items, bibliographic information, interests, and photos. By way of example and not limitation, a musician may include information such as genres that represent their music, instruments they play and their associated experience, past band and venue experience, and other information. Musicians and bands may further upload and/or add music to their profile page, including tracks, songs, and playlists. Listeners may also create playlists and post to their page. Further, uploaded photos may be managed, reordered, associated with other users, songs, tracks, or playlists, identified as the profile page main photo, shared, and/or downloaded, if the user allows for downloads and shares. In another embodiment of the invention coders and software programmers may add code and upload photos to their profile page.

After registration, users may view other user or band profiles, view, listen, review and/or download music, create customized playlists, message other users, comment on photos, tracks, songs, and playlists, and share photos and music, amongst other actions. Each user and associated profile page is given access to a GUI-accessible messaging system. The messaging system can be provided in numerous embodiments, included but not limited to self-contained real-time and/or email messaging systems, or real-time and/or email messaging systems integrated with third party software(s) and/or device(s). When the interface is viewable through a mobile device, one embodiment of this invention allows for messaging to occur within the mobile device's own application, thereby storing the messages on the mobile device itself. In one embodiment of the invention, users may share comments, photos, music, profiles or any other features or data of the website to a number of social media websites or third-party applications, such as those used for music composition. Notably, tracks downloaded or emailed from this invention's GUI can be easily mixed offline. In another embodiment, software programmers and coders may access the GUI through a mobile device and have messages stored on the mobile device itself

Any user may create customized playlist(s) by selecting music available on the website that is publically available, or, if granted access, privately available music as well. By visiting user or band profile pages within the website, music in the form of tracks, songs, or playlists may be click-selected and added to the user's particular customized playlist. These playlists may be private, viewable only to the user and any other invited users, or public and available to all users and visitors via the user's homepage. In this manner, a user may create a plurality of playlists, each click-selection able to added to any one or plurality of playlists. Further, a user can selectively add or copy another user's entire playlist and/or a band or musician's playlist, so long as the playlist or each music selection has properties allowing for the playlist addition. These allowable properties may include whether the music is considered publically or privately available, whether the music is made available to be added to playlists specifically, and whether the user wishing to add the music to a playlist has provided any required compensation or granted any required access. Further, playlists, or portions thereof, may be publically or privately available, effectively granting a user the additional quality of being a producer having revenue generation capabilities. In another embodiment of the present invention, code may be made publically or privately available.

In one embodiment of the invention a user may create a playlist or song in the form of a sound library. Alternatively, a sound library may be hosted by the website itself Various track samples or contributions can be added to the sound library and made either publically or privately available.

In one embodiment of the invention, a streaming radio channel may be created by the user. The streaming channel may be accessible through the website or through an application specifically tailored for a mobile device. A user may create the streaming channel by selecting a particular genre or combination of genres, selecting a playlist, or band, or choosing parameters and allowing automatic creation of a channel based on the parameter selections.

In the methods of the present invention, musicians may register a band or create a virtual band through the GUI. A band can be created by a registered user simply creating a band profile page and providing the relevant profile information, such as genre, images and other personalized information, as described above. A virtual band may be created by several methods. According to one embodiment of the present invention, anyone on the site can also audition to be in a band by uploading an independent track for a band to review or by uploading a track related to a band's song. The band members, song contributors, or subsets thereof, receive notification of the audition track upload so that the track may be reviewed. The band member, song contributor, or subsets thereof, can then accept or reject the auditioning musician and send a notification of that selection.

According to another embodiment of the present invention, musicians may also participate in bands by starting a band profile page and inviting other users to join. A band can be created to grant permission to one, some or all band or guest members to invite other users to join the band. Band members have access to all the tracks and uploads of other members of the band. One embodiment of the inventions permits band members to collectively approve changes through voting. In general, however, once a song is created, the song designations (revenue-sharing, etc.) are established and can only be changed later by vote of majority. In another embodiment of the present invention, software programmers may invite other programmers or coders to collaborate or accept invitations from other programmers or coders to collaborate.

The acceptance of a musician into a band may be as a full band member or as a guest member. The permissions and accessibilities of each are determined relative to the band profile settings, but a guest band member generally has less access and permissions than a band member. Particularly, a guest member is limited to modifications pertaining to the particular song, songs or playlist to which the guest member status is associated. A guest band member is a guest musician who is invited or who is accepted by the band via an audition to collaborate on a song, although the guest may be invited or accepted to collaborate on additional songs, individually. New members may be permitted to upload tracks to various songs, download and/or view private band tracks, designate track-songs, invite other users to join the band, request and review auditions, and/or edit the band profile page. Notably there is no limit to the amount of bands a user may join or be a member of for musical collaboration. Band members may view revenue, listen, download, and upload analytics through the band profile page. In another embodiment, a software programmer or coder may be a team member or be a guest team member.

Importantly, the musicians do not need to ever be in proximity or create a track contemporaneously; rather, the collective contributions through the site over time create the tracks and ultimately the song-track to represent the song to the public. As there can be multiple tracks within one song, and therefore multiple versions of a song, different combination of tracks may be provided collaboratively through the site from the same or different musicians. Tracks may be provided in a multitude of file formats and the invention may allow for the files to be converted, compressed, or remain in their original formats. Any or all of these tracks may be either privately or publicly available, as set by one, all, or a subset of the track or song collaborators; otherwise the first track added for a song may be deemed the song-track by default. Additionally, band and/or musicians may choose which tracks and/or songs may be displayed in the player on their profile page. Each uploaded track is provided with a title and an optional description by the user uploading the track, although this information may be edited at a later time. Tracks and songs may be searchable either publically or privately by the users of the invention. Depending on the settings, comments may be added, deleted, and edited by users for each track and song created. In another embodiment, software programmers or coders do not need to be in proximity or work on software contemporaneously.

In one embodiment of the invention, the user who uploads a first track of a song can opt to be the song owner or select which users or user-categorize are granted ownership. The song owner may choose to accept or reject any tracks or track versions uploaded into a song folder, designate a revenue plan for the song, edit certain song tracks, descriptions and titled, grant permissions to other users, and regulate the song and track's general usage and properties. In another embodiment of the present invention, a user who uploads the first code of a software program can opt to be the owner of that software program or grant ownership of that software program

Although one embodiment of the invention permits tracks to be uploaded through the GUI of the invention, tracks may be also uploaded from a variety of devices or third party applications (such as GarageBand) by sending the track file to an associated song email address. Upon creation of a song, a band member or musician may optionally allow for the creation of an associated email address unique to that song. Once created, the present invention may optionally allow for tracks to be emailed as attachments to the song email address and automatically placed in the song folder for review. The song email address may be publically accessible or privately accessible. Additionally, the track may be automatically labeled according to genre, based on the composition of the virtual band, when placed in the song folder. If the the user does not have permission to automatically upload the track to the band or song, a reply may be sent informing the sender of the track of such. Further, one embodiment may allow for metadata to be delivered with or without a track file to be automatically uploaded and integrated into a user or virtual band profile. Such metadata may include a photo or video taken with a mobile device and associated with a particular playlist, track, song, or band.

Tracks, and particularly song-tracks, may be made available for download or sale by the band members, song creators, or song contributors. Varying tiers or degrees of public/private designations may be associated with each song or track. These designations are applied to whether the tracks are able to be played, downloaded, added to a playlist, bought, shared or viewed by band members, song creators, song contributors, all users or all visitors for free, permission or compensation. Varying combinations may be applied. For example, and not by limitation, a song-track may be freely available to add to a playlist, which must be granted permission by at least one band member who is not a guest. In another embodiment of the invention, code and software programs may be available for download or sale. Uploaded tracks and created songs may be categorized within at least one genre selection on the website. The present invention also provides for auto-generation of genre labels based upon the band member composition, contributor genre composition, or other factor considerations. In this manner, auto-upload of tracks through song email address may be automatically designated to a particular genre so that users and visitors can discover this new music immediately upon upload by search by genre. In another embodiment, code and software programs may also be categorized.

The present invention is illustrated by the interactive website for www.myblogband.com, which includes an Internet and mobile application with specific functionality for providing virtual collaboration for musicians for creating and editing composite music tracks from a multiplicity of remote musician entities. This interactive website application is operable to provide users with the ability to create and/or join a band remotely from the other musicians in the band, by accessing the site for collaboration via a network, such as the Internet in a virtual workspace for multiple users. In an alternative embodiment of the present invention, Internet and mobile applications with specific functionality for providing virtual collaboration for software programmers and coders is provided.

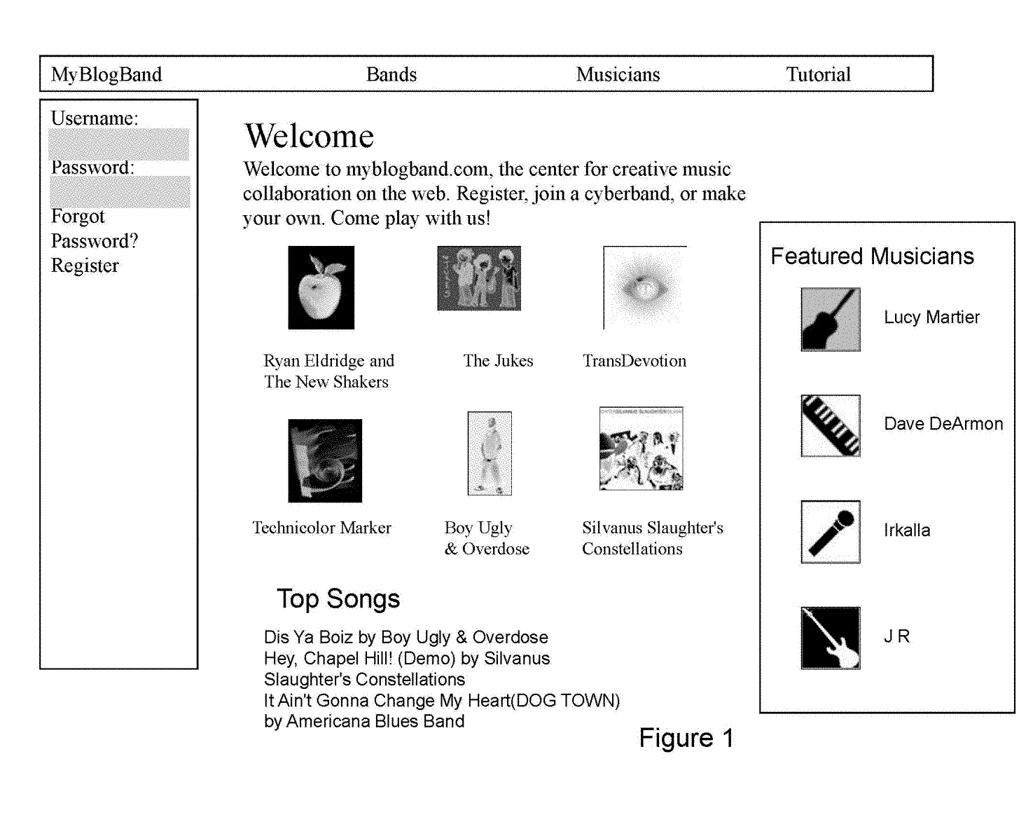

Referring now to the drawings specifically, FIG. 1 provides a home page GUI for a website operating according to one embodiment of the present invention. The figure discloses several interactive options for users and visitors, including a tutorial, profile creation and log-in functionality, tabs that link to search capabilities, and sections featuring bands, musicians, and songs that may be compiled and displayed according to their relevancy. By way of example, but not a limitation, the compilation of these displays may take into consideration the IP address of the visitor, profile characteristics of the user, any logged user or visitor history, recent events or trends, random generation methods, or a combination thereof

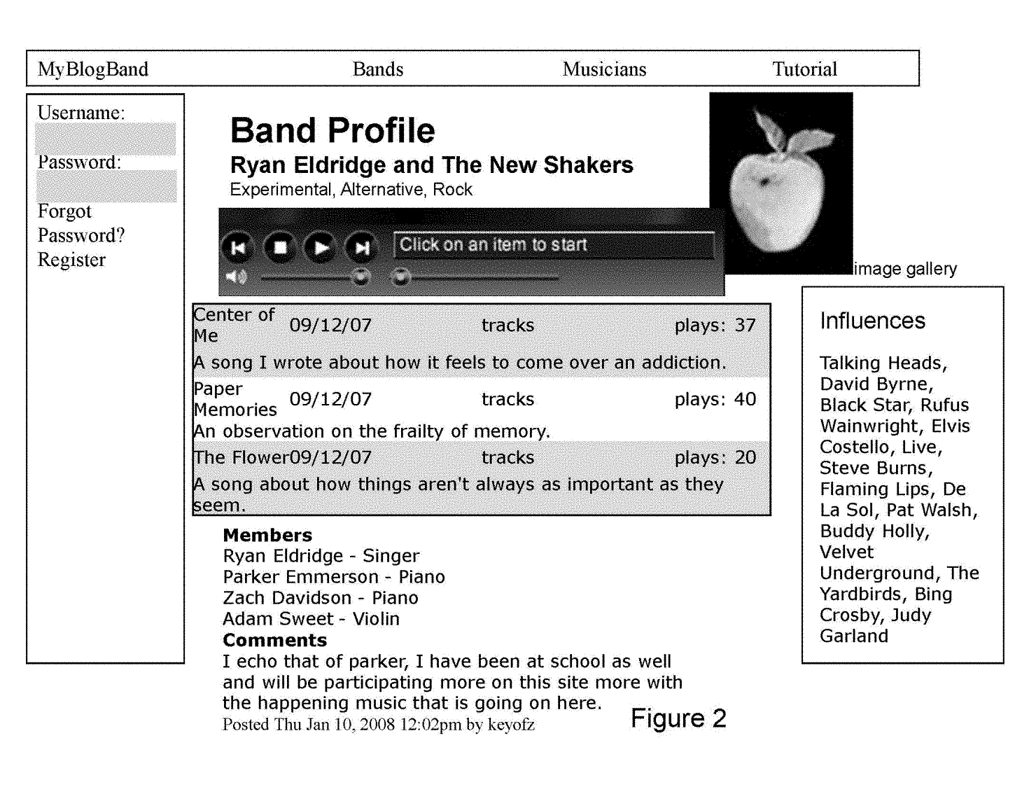

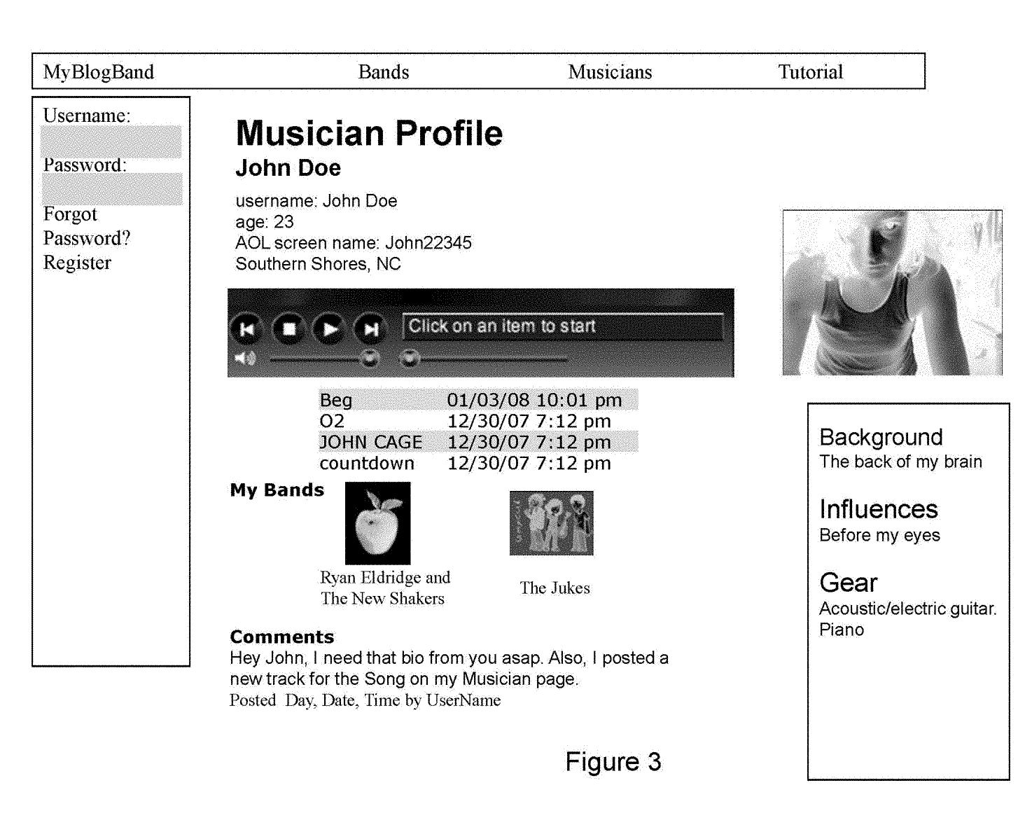

FIGS. 2 and 3 provides two embodiments of GUIs for users or visitors to view a selected band or virtual band profile page, including the songs and song information, genres, band member information, band information, band images, and related comments. The GUI also allows the user or visitor to listen, download, and add songs to playlists. Additionally, if available of the user or visitor, tracks for a song may be viewable.

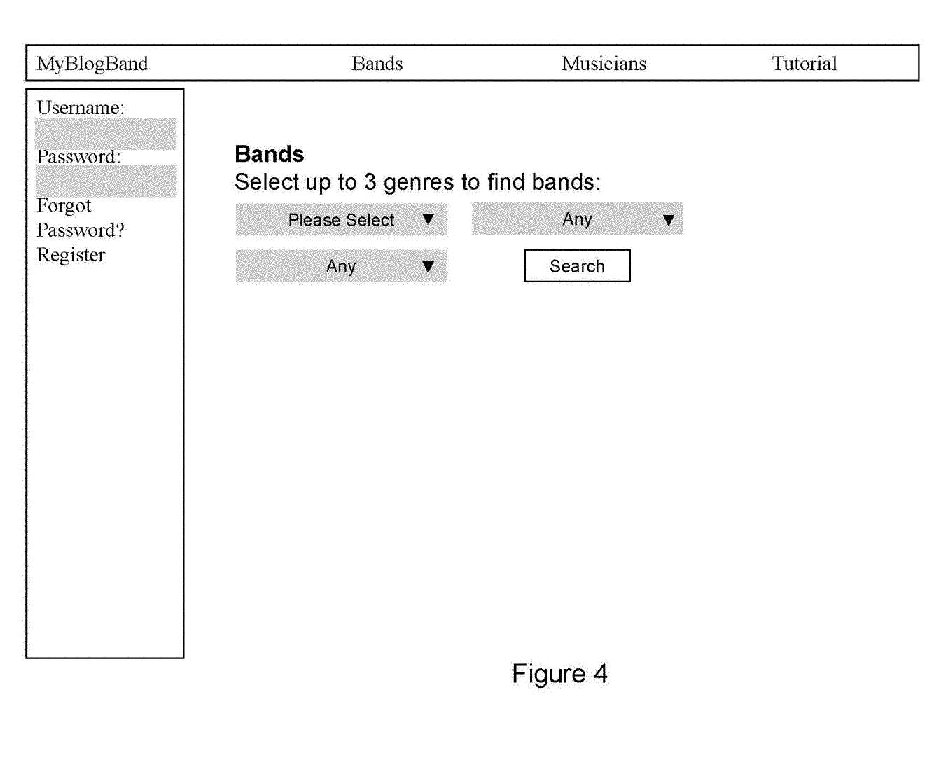

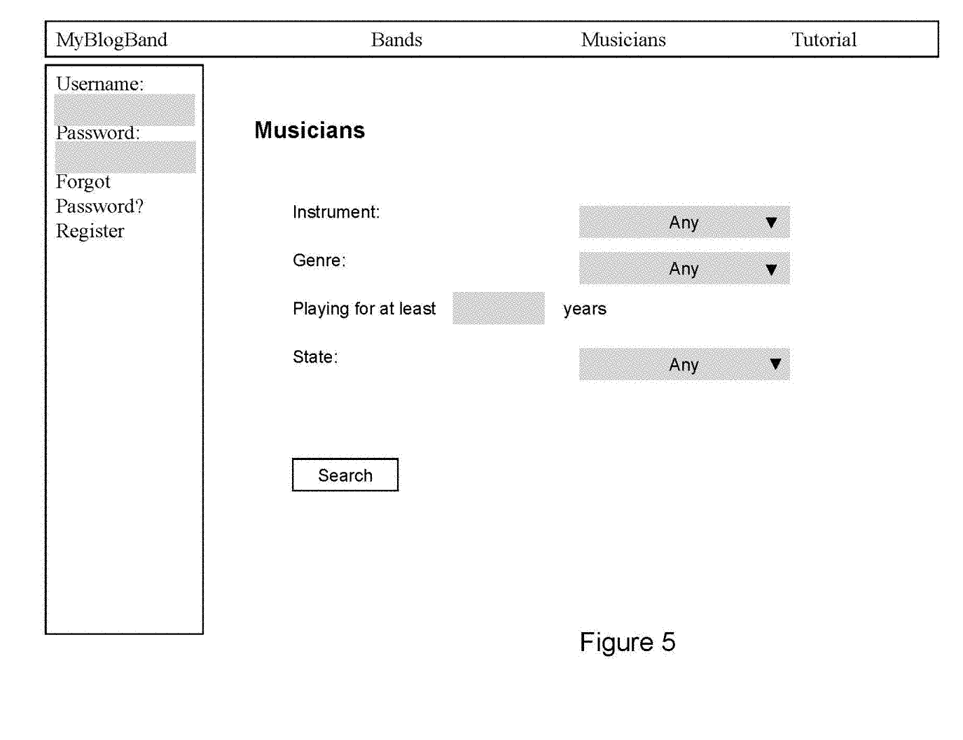

FIGS. 4 and 5 provide two embodiments of GUIs for searching entities within the website. FIG. 4 provides an embodiment for searching for bands by music genre, whereas FIG. 5 provides an embodiment for searching for musicians by various criteria, including instrument, music genre, years of playing experience, and geographic location. A similar approach may be applied to musicians, virtual bands, listeners, or any other entity within the website. Additionally, other search criteria may be provided.

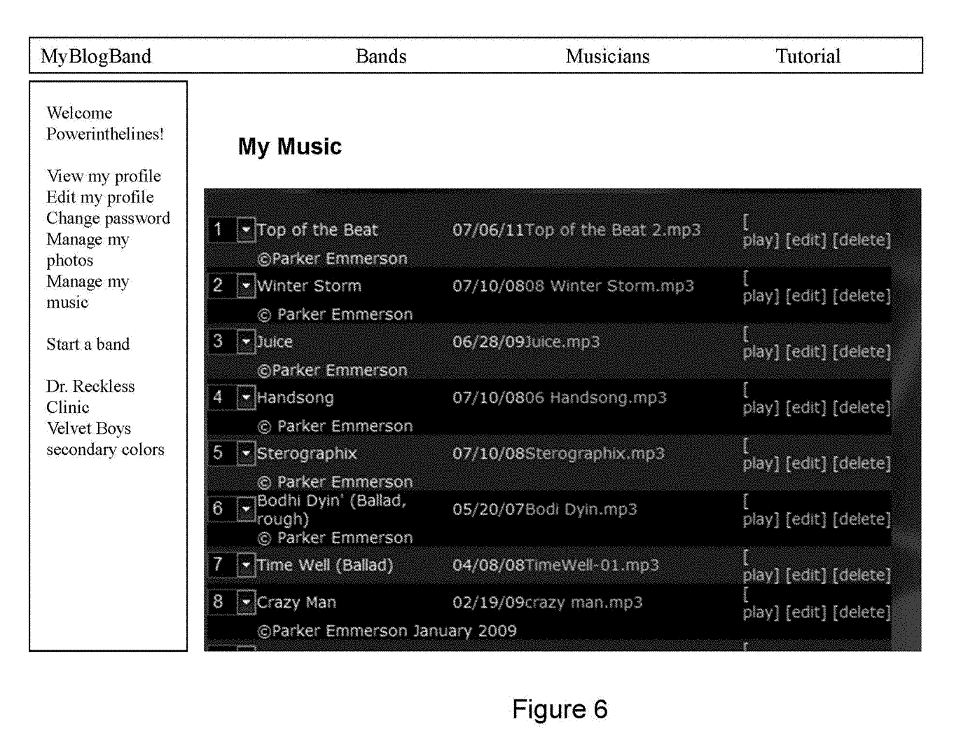

FIG. 6 provides one embodiment of a GUI for a registered user to manage the user's account or profile, including editing personal information, review options, photo management, music and playlist management, and a band creation option. Links to band or virtual band profile pages, of which the user is a member, guest member or fan, may be provided. In the embodiment disclosed in FIG. 6, a user's playlist, entitled “My Music,” is displayed. Track and song options, such as playing, editing, deleting, downloading, sharing or other options, may be provided. Metadata, such as upload date, playlist date, file type, song genre or other data, may be provided.

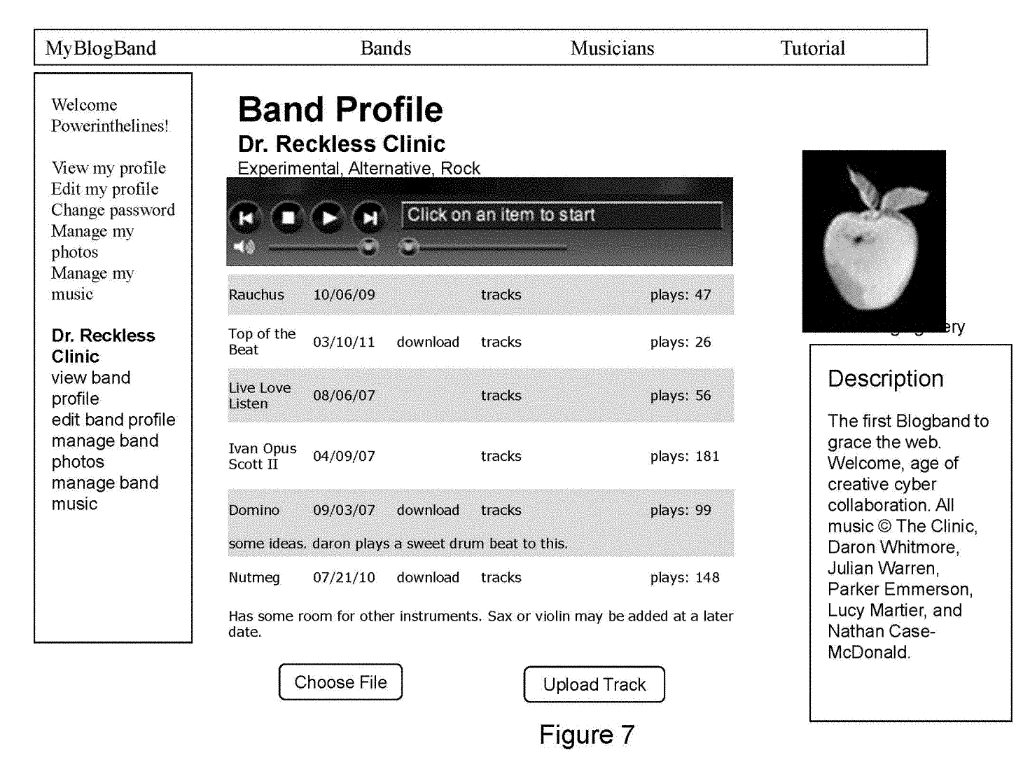

FIG. 7 provides one embodiment of a GUI for a user to manage a band or virtual band. The songs and/or tracks may be individually listed with associated metadata, including but not limited to upload date, number of plays, popularity, or relevancy to the visitor. Additionally and if permitted by the song or track's attributes, download, add to playlist, or share options may be provided.

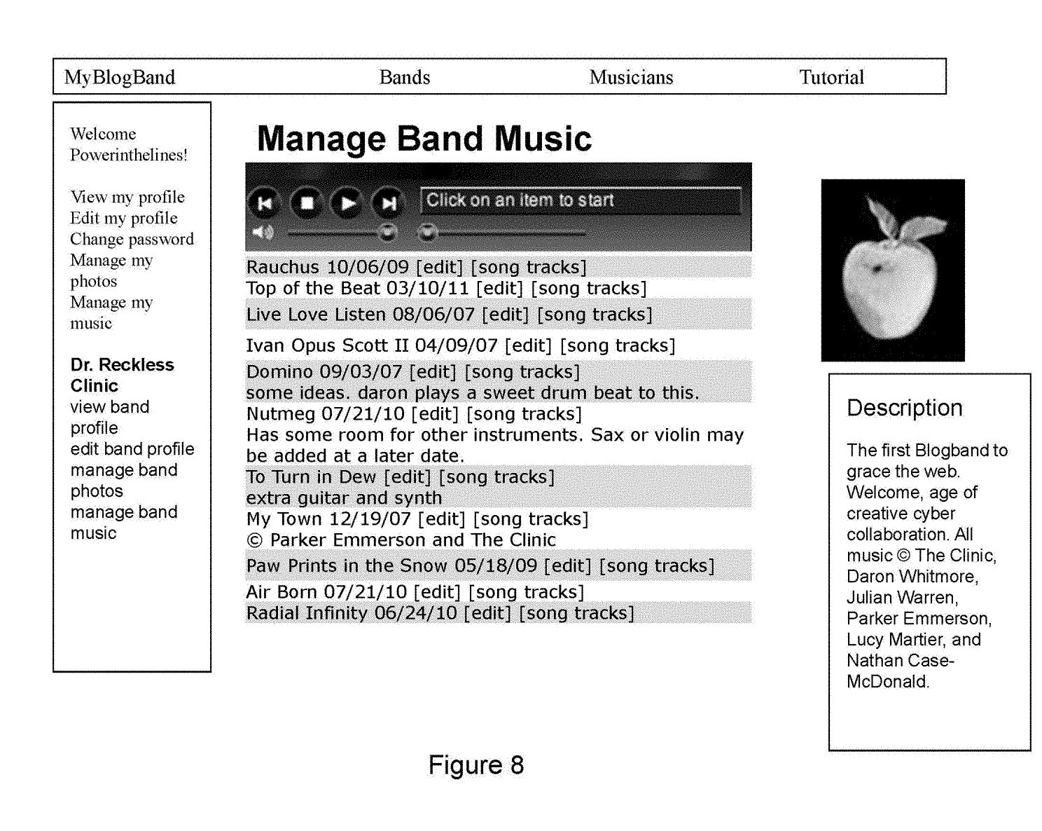

FIG. 8 provides one embodiment of a GUI for a for a band member to manage the band or virtual band music, including selection of tracks as song-tracks.

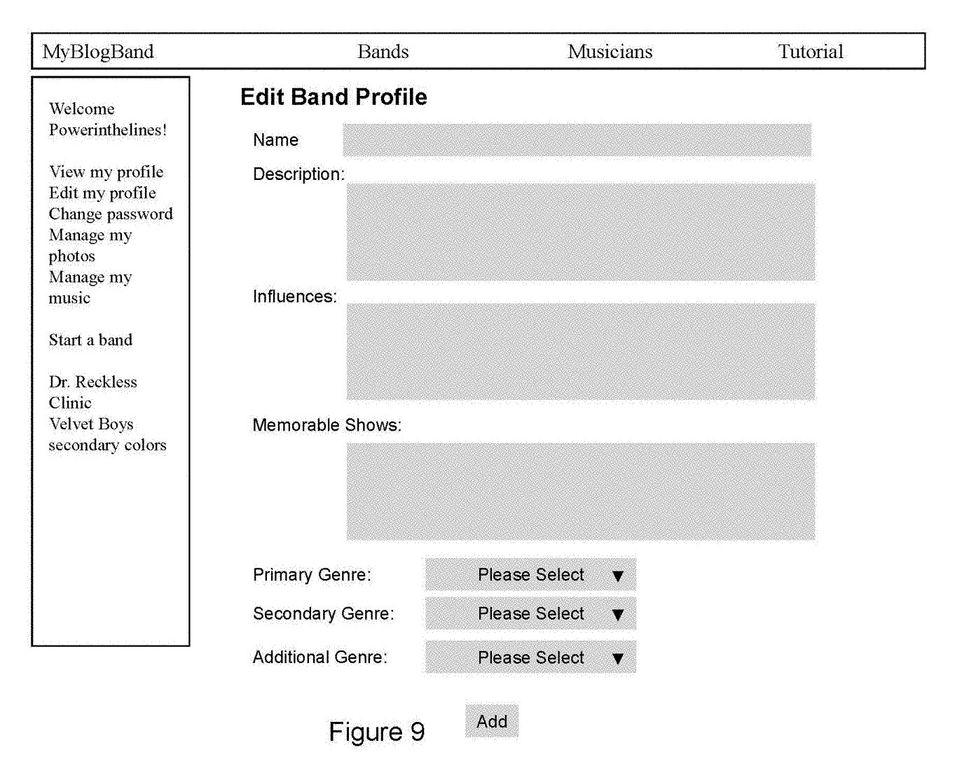

FIG. 9 provides one embodiment of a GUI for a for a band member to manage the band or virtual band profile information.

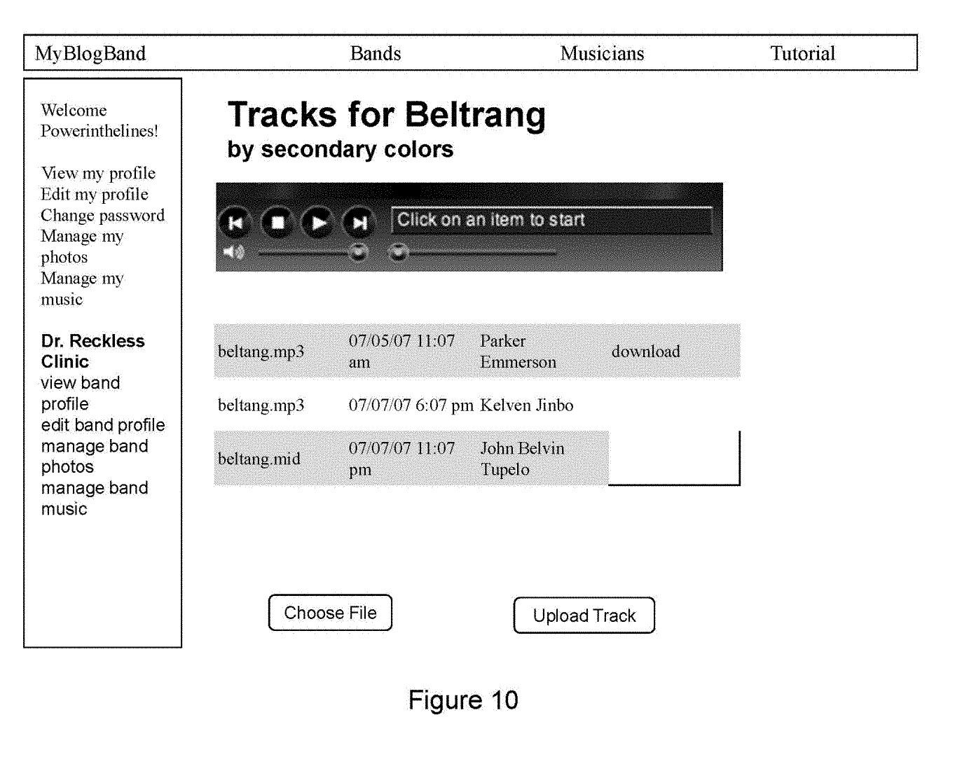

FIG. 10 provides one embodiment of a GUI for managing a song and the associated tracks. In FIG. 10, for illustration purposes, three tracks are shown, each track being separately uploaded by different musicians at different times.

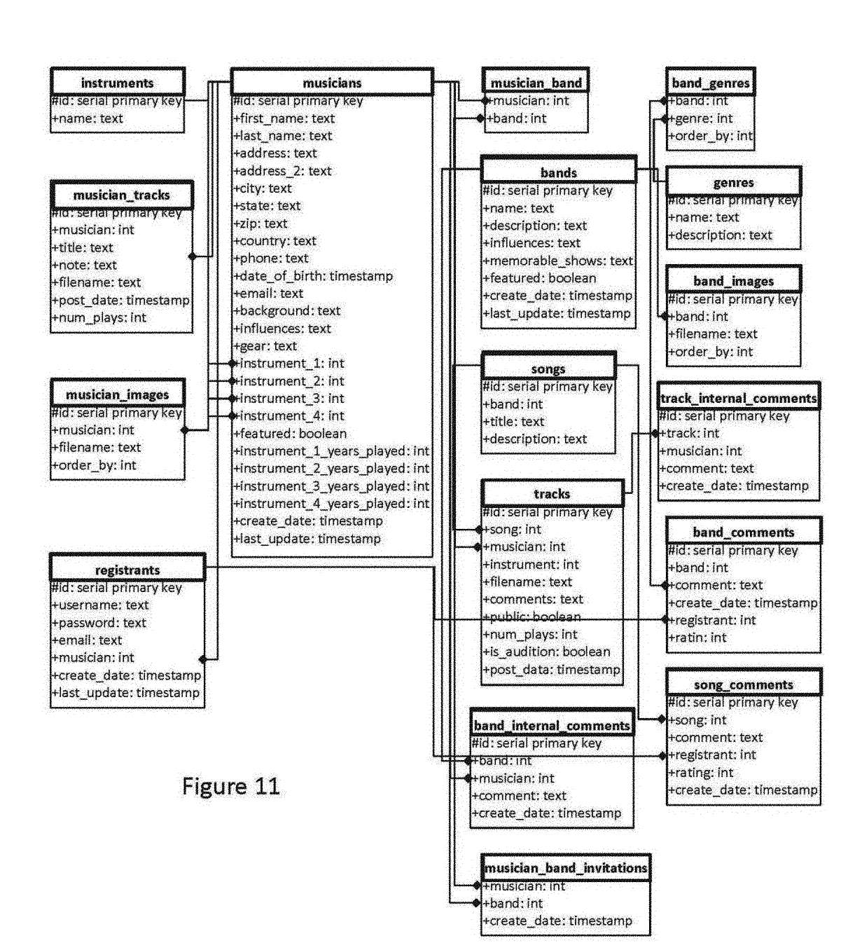

FIG. 11 provides a data table architecture of a website according to the present invention.

In-App Uploading to Myblogband

The streamlining of content to a website that uses the Blogband patented technology is a useful, unique feature that exemplifies the framework of Blogband's technology. There is a need to make it easy for people who are using a third party mixer, digital instrument or other recording and music creation software to upload their original content to the Blogband network and select exactly where it is placed within their accounts and within the social network. This is envisioned by giving the user access to a filing path system within the actual application (“app”) running on a tablet, computer or mobile device. The filing path system is a representation of that user's content management system set up on the Blogband network with that user's profile and account accessible within the app for the purposes of uploading content. The file path is a representation of the user's Blogband network profile.

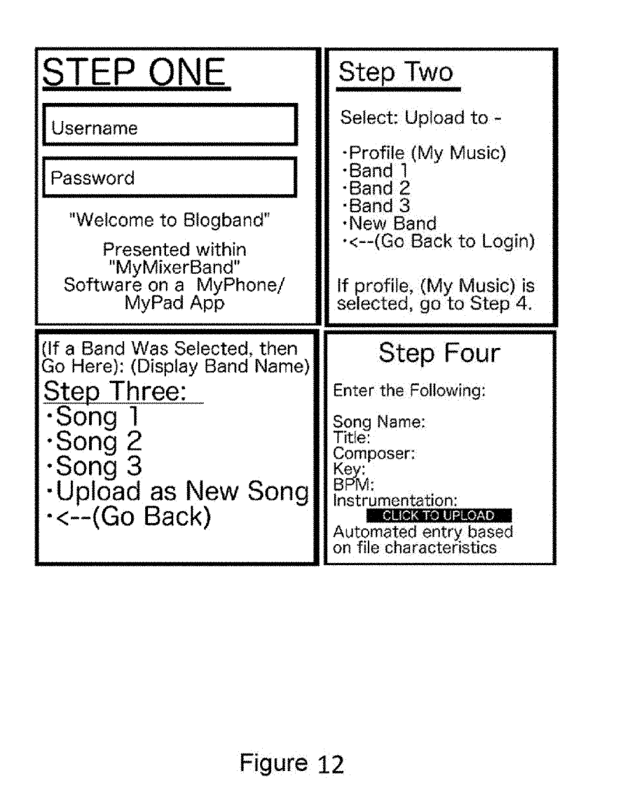

Content upload is thus facilitated with ease, because users can access their accounts within an app and also share content of the same mixer format. Files can be shared as lossless, compressed or as full mixer files of the respective application used to remotely edit content shared over the Blogband network. FIG. 12 illustrates the steps of uploading contents to the Myblogband network via an application.

Collaboration Platform

The present invention proposes a collaboration platform for different forms of projects with separate or unified sites for each specific area of collaboration. Files in one project are exchanged remotely like on myblogband.com for music collaboration.

In one embodiment, musicians collaborate for musical composition via the collaboration platform as described above.

In another embodiment, a team of users collaborate for video projects on the collaboration platform of the present invention. Video projects can be sub-divided into “chapters.” Finalized video clips and/or sections are displayed on the team page or within a particular team's respective project pages.

In another embodiment, the proposed collaboration platform is used in Construction, Architecture and Development (CAD). A CAD team is like a band, a CAD project is like a song. CAD Projects are managed in terms of jobs/positions (e.g., architect, construction manager, budget manager, draftsperson, etc.). In an analogous way, instead of songs displayed in the band page player, one would have the most updated versions of each sub-section of a collaborative construction-themed work accessible through a separate project page where categories of a project are listed. For example, the categories within a sub-section of a distinct project includes budget, drawings, materials lists, legal document, etc.

Similarly, the collaboration platform of the present invention can be used for programming and software development, aerospace collaboration, industrial design collaboration, etc.

Tokenization of Media Content

Virtual items in games can be included in the ownable content transferable over a blockchain, because a respective private key can be used to sign ownership or access to a virtual item over from one individual or user to another. Virtual weapons, clothing, items, cars, or any acquirable object in a video or computer game can be tokenized, held, synchronized between games for different devices, terminals, consoles, or between games for different meanings, and are transferable between users or players. Similarly, media content in the present invention can be tokenized through a digital media crypto-wallet.

Revenue Generation and Distribution.

A track, song-track, or playlist may be offered for sale through the present invention. A sale may grant the buyer permission to play the item, download the item, or add the item to a playlist. In one embodiment of the present invention the profit generated (revenue less costs) may be automatically distributed to the collaborators (band members, guest band members, musician, and/or producers) in a variety of ways. Costs may include any number of overhead, usage rights, or identified static costs associated with the site, collaborator, playlist, track, song, or third-party website, software provided or device. One embodiment of the present invention also offers interaction with other websites, including music-selling websites (e.g., iTunes, Amazon, CD Baby, etc.). In another embodiment of the present invention, licensing services may be offered to bands and musicians.

The allocation of revenue can be modified according to users' preferences, including, but not limited to an equal distribution of profits by percentage to each collaborator, a tiered distribution of profits by percentage to each collaborator, or a tiered distribution having fixed distribution amounts extracted before distribution to other collaborators. Further, the distribution schemes may include additional users or exclude certain collaborator or collaborator types. Additionally, the profit allocation may be remitted in numerous forms, including but not limited to peer-to-peer digital currency such as Bitcoin, foreign currency, through a third-party account or Automated Clearing House (ACH), and held in a user account created through the website, and/or through a physical check. Conversion from any native currency to any foreign or account currency may be available, optionally at an additional cost to the payor of a fee or the receiver of a profit. Additionally, user-agreed upon barter systems may be established, with the optional integration of the aforementioned remittance methods or services being integrated. Third party services such as PayPal and Bitcoin can be integrated into the website GUI for ease-of-use. Any of these services may have associated additional costs. In another embodiment of the invention, these services may also be available for an interactive website for virtual software collaboration.

In one embodiment of the invention, featured bands, songs, and/or musicians may be displayable on the homepage or within advertising space throughout the website. The inclusion of particular music or users into these featured displays may be based on merit, such as “likes,” downloads, plays, or other properties, or may based on fees paid. Furthermore, competitions, awards, and prizes may be created and displayed in various areas of the website. In another embodiment, featured programmers or software programs may be displayable on the homepage or within advertising space throughout the website. Competitions, awards, and prizes may also be available for programmers and coders on a website providing methods for virtual software collaboration.

Another embodiment of the invention may incorporate permit real-time functions and software such as a visualizer that can connect to the playing of music, real-time audio, video and/or text communication, and virtual jam sessions. By providing virtual access to users through the website GUI, virtual band members may create virtual tracks and live concerts by recording live sessions or by combining uploaded tracks with live, real-time recordings.

Licensing Via Bitcoin/Myblogband Social Network.

There is a need in media industry especially for online music network to stop people from copying or downloading music for free. The invention here is to use an cryptocurrency network (e.g. a bitcoin network) to facilitate licensing of media be it video, audio or visual.

A custom-tailored cryptocurrency network is proposed for the express purpose of granting media licensing on the basis of distributed, cryptographic ledger technology. A license node has an up-to-date record of the presence of all licenses. A license authorization key is generated by the cryptographic network when a content owner/provider/generator receives payment via the aforementioned custom currency or other currency. Both the data for media and the license authorization key by which the data is allowed to be media are direct sent to a user on the network. Each user has a media wallet that can organize and categorize different kinds of licenses to different kinds of media using a multitude of cryptocurrency platforms including the cryptocurrency platform that has been custom-tailored to make media licensing easier.

Licenses generated over a cryptocurrency network have different purposes, such as granting right to perform a song, to play the song in a venue, to copy the song, to sell the song, and/or to distribute the song. There are multiple embodiments of licensing media over a cryptocurrency network.

One embodiment is to license media through a license node with individual licenses to particular pieces of media stored on a cloud server. However, another embodiment is to license media through a license node with individual licenses to particular pieces of media stored on a distributed ledger, downloaded by each user of the digital media wallet node software. Running a digital media wallet node entitles a user to be part of the global revenue generated by transfers of digital media wallet licenses.

Given an individual piece of media, for example a song, entitled “Song 1,” authorization to play the song, copy the song, transfer the song or sell the song would be granted using a license authorization key issued by a cryptocurrency network such as the bitcoin network/protocol. A user's online account would be credited with access to the media over a suite of different hardware/software platforms that have access to this data stored on “the cloud.” License authorization keys that grant access to the media would be stored on the cloud and all the users would have to do is to log into their accounts. Users could transfer those license authorization keys to be stored locally on hardware. A “wallet” software is used to organize the license authorization keys that grant access to data, therefore turning it to consumable media. The wallet organizes both the data and license authorization keys as a cryptocurrency node on the cryptocurrency network via a GUI such that it is easily accessible through a browser. In this embodiment, the keys are still held on the cloud, so the media is accessible wherever the data is available so long as the user is logged into his cloud account.

By means of access to the cloud account, the user may transfer these licenses using a website or by having his local media wallet transfer the license authorization keys from the cloud server to another wallet or cloud account. Any format of media may be transferred.

The cryptocurrency network maintains the history of all transfers/transactions that take place. Data is downloaded from many different distributors and platforms, with the downloading/receiving of data, license authorization keys to access the data are also conferred to a user (licensee) with a public address. The license authorization keys are held on a cloud server or local disk. Both the data and the license authorization keys are made available to the user through his “media wallet.”

Once the user has the data, the license authorization key or the balance which is enshrined by the cryptocurrency network at a particular address grants access to the data, thereby turning it into media, because a centralized or distributed database of media files verifies the presence of the correct keys at the cryptocurrency node through either proof of stake (proof that there is the presence of the key) or transfer of the key one time per media usage to the owner's own wallet.

Another embodiment is to license media with individual licenses to a host of media stored on a cloud server. The owner of a license authorization key that corresponds to the correct respective value on a cryptocurrency network is also granted access to a subscription style service of media.

Yet another embodiment is to license media through a license node with individual licenses to particular pieces of media stored on a local server/computer/hard-drive/wallet. Data is downloaded and locally stored license authorization keys grant access. The license authorization keys can be transferred from one address to another address on a cryptocurrency network or the balance located at an address that signifies access to the data can be sent to another address, and thus access to the media is conferred.

Yet another embodiment is to license media content through a license node with individual licenses to a host of media stored locally.

A web bot crawls a block chain (distributed ledger) to check that a user possesses one of the private keys corresponding to a public key that has been authorized through a cryptocurrency transaction to play a song.

Digital Media Wallet/Licensing Platform on Hand-Held Devices

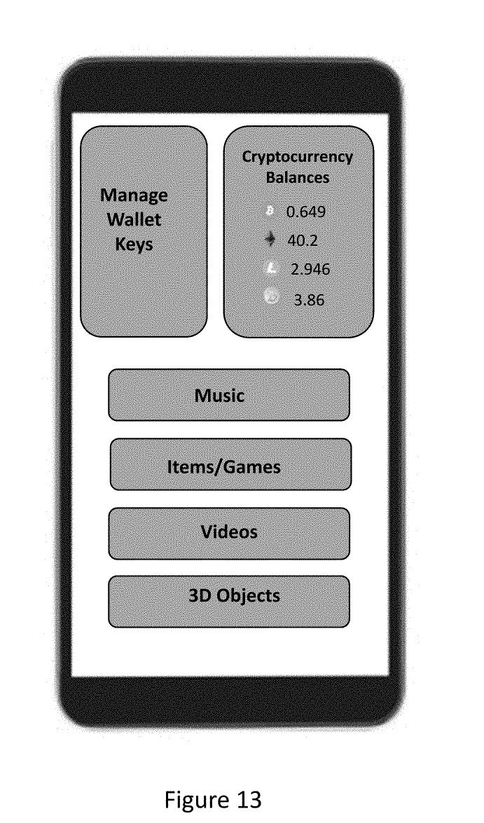

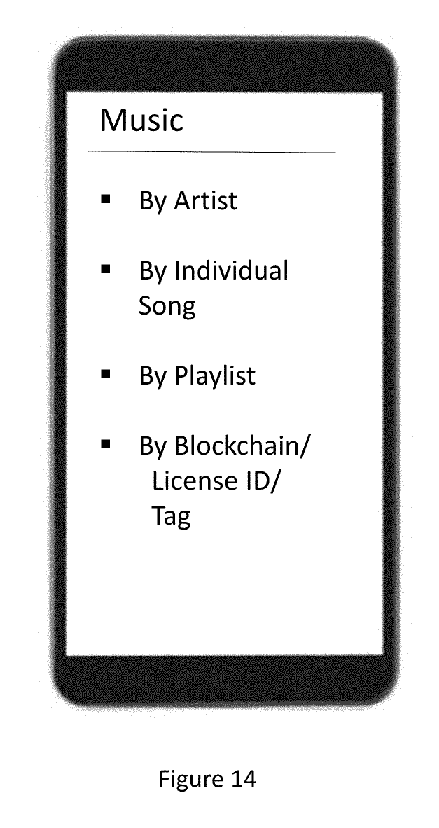

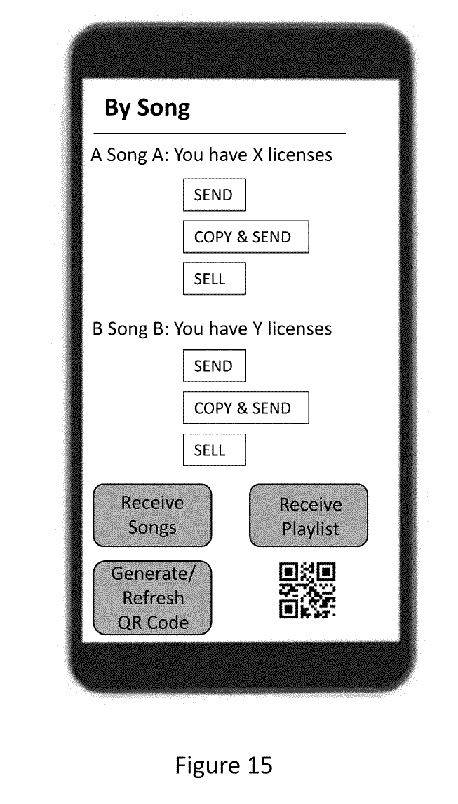

FIG. 13 shows a user interface of an application program (“app”) for a licensing platform with a digital media wallet on hand-held devices. A user can manage his digital wallet keys, and view his cryptocurrency balances. A user can license music, games, videos, 3D objects, etc on the licensing platform. If “music” is selected, a user can choose music by artist, by individual song, by playlist, by blockchain, license ID number, or tag, as shown in FIG. 14. The playlist of the music is metadata. If a user decides to view the music by song, a list of songs are displayed as shown in FIG. 15, which indicates the number of licenses the user has. The user can choose to send a song, copy&send a song, or sell a song. The app also enables a user to receive songs, receive playlists, generate or refresh a QR code. When a user sends a song, they either lose one of the functioning access license codes to the song or copy the license as they send it, paying a crptocurrency license fee to the original artist. Users can receive music by presenting a crpto-graphic blockchain address to another user of the platform, and the “second” user can scan that code to send the music to the “first” user.

Blog Band Bot

The present invention also proposes a band curator bot or a band manager bot (“Blog Band Bot”), which helps formation of bands and collaborative groups by making suggestions based on different criteria and/or categories and promote and distribute the works of bands. A Blog Band Bot is an artificial intelligent robot in the form of an autonomous computer entity or user. The Blog Band Bot is created based on certain algorithms on the collaboration platform.

A Blog Band Bot establishes an original account on myblogband.com therefore has access to an email replay/address in advance. After creating some basic profile information, the Blog Band Bot then asks a user online from social networks (e.g., from Twitter, Facebook, a host of different feeds, but primarily myblogband.com itself) if the user wants to join a band created by the Blog Band Bot. The band is named based on trending content from across the web. There can be genre-specific Blog Band Bots, and a Blog Band Bot can just be a member of very many bands. If a band member feels like an instrumentalist is missing from his band, the band member can asks a Blog Band Bot to find the most suitable musicians in a chat framework. The Blog Band Bot have chat functions to show suggestions. The Blog Band Bot is also operable to locate emerging music on social network.

Criteria used for searching for potential band members by Blog Band Bots include {genre, tempo, time signature, instrumentation, “liked by”, etc.}. Blog Band Bots can search a profile database of myblogband.com.

In one embodiment, a Blog Band Bot is operable to source musicians for a band in social networks (e.g., Blogband, Twitter, Facebook, YouTube, etc.).

In one embodiment, a Blog Band Bot is operable to source fans and listeners for a band in social networks. For example, if fans like reggae, then invite fans to a reggae group, not a pop group.

In one embodiment, a Blog Band Bot is operable to source concept for bands from what is trending on social networks.

In one embodiment, a Blog Band Bot is operable to incentivize musicians. For example, a Blog Band Bot is operable to prompt musicians to upload new content, advertise new content, and attract users. A Blog Band Bot is also operable to facilitate content licensing in a cryptocurrency network such as ethereum, bitcoin, etc. Also for example, the more collaborations a track has, the higher it gets posted.

In one embodiment, Blog Band Bots can eventually make beats and improvise guitar riffs too.

In one embodiment, Blog Band Bots post own scripts to be edited by other Blog Band Bots.

Certain modifications and improvements will occur to those skilled in the art upon a reading of the foregoing description. By way of example and not limitation, methods for providing a filing system for playlists or collections of tracks that provides for multiple musician and/or multiple group collaborations as set forth hereinabove. Also, a business model including the methods hereinabove wherein advertising is sold for generating targeted traffic for music, including the use of musical keywords wherein each music genre has keywords specifically associated with it so that advertisements can address niche markets related to those genres. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for granting media licensing, comprising:
a multiplicity of cryptocurrency nodes in a distributed cryptocurrency network tailored for media licensing;
wherein the multiplicity of cryptocurrency nodes comprises at least one media licensing node and at least one media licensee node;
wherein the at least one media licensee node is operable to make payment for a piece of media to a media licensing node owning the piece of media through the distributed cryptocurrency network;
wherein the distributed cryptocurrency network is operable to generate a license authorization key to the piece of media;
wherein the at least one media licensee node is operable to receive data for the piece of media data and the license authorization key after making the payment; and
wherein the license authorization key is operable to convert the data for the piece of media to a piece of consumable media at the at least one media licensee node.

2. The system of claim 1, wherein the piece of media is selected from a group consisting of videos, audio, and images.

3. The system of claim 1, wherein the piece of media is stored on a cloud server.

4. The system of claim 1, wherein the piece of media is stored locally.

5. The system of claim 1, wherein the license authorization key grants right to perform the piece of consumable media, to play the piece of consumable media, to copy the piece of consumable media, to sell the piece of consumable media, and/or to distribute the piece of consumable media.

6. The system of claim 1, wherein the license authorization key grants access to a subscription-style service of media.

7. The system of claim 1, wherein the multiplicity of cryptocurrency nodes are digital media wallets operable to organize and categorize different kinds of licenses to different kinds of media.

8. The system of claim 1, wherein the license authorization key is operable to be transferred and stored locally.

9. The system of claim 1, wherein the distributed cryptocurrency network is operable for verifying the presence of the licensing authorization key at the at least one media licensee node.

10. The system of claim 9, wherein verifying the presence of the licensing authorization key is performed through verifying ownership of the licensing transaction key.

11. The system of claim 9, wherein verifying the presence of the licensing authorization key is performed through verifying transfer of the licensing authorization key one time per media usage to the at least one license node.

12. The system of claim 1, wherein each of the multiplicity of cryptocurrency nodes has a public address.

13. The system of claim 1, wherein the distributed cryptocurrency network is a bitcoin network.

14. The system of claim 1, wherein access to the data for the piece of media is granted based on a balance at the at least one media licensee node.

15. The system of claim 1, wherein the distributed cryptocurrency network is operable to maintain a history of all media transfers and transactions.

16. The system of claim 1, wherein the at least one piece of media is created over a collaboration platform.

17. The system of claim 16, wherein the distributed cryptocurrency network is integrated into the collaboration platform.

18. A method for granting media licensing, comprising:
providing a multiplicity of cryptocurrency nodes in a distributed cryptocurrency network tailored for media licensing, wherein the multiplicity of cryptocurrency nodes comprises at least one media licensing node and at least one media licensee node;
the at least one media licensee node making a payment for a piece of media to a media licensing node owning the piece of media through the distributed cryptocurrency network;
the distributed cryptocurrency network generating a license authorization key to the piece of media;
the at least one media licensee node receiving data for the piece of media and the license authorization key; and
the license authorization key converting the data for the piece of media to a piece of consumable media.

19. The method of claim 18, further comprising the distributed cryptocurrency network verifying the payment.

20. The method of claim 18, further comprising the distributed cryptocurrency network granting access to the piece of media based on a balance at the at least one media licensee node.
